(19) United States
(12) Patent Application Publication
(10) Pub. No.: US 2012/0187870 A1
(43) Pub. Date: Jul. 26, 2012

(54) LIGHTING DEVICE AND LUMINAIRE

(75) Inventors: Naoko Iwai, Yokosuka-shi (JP); Hiroshi Kubota, Yokosuka-shi (JP); Masahiko Kamata, Yokosuka-shi (JP); Hiroshi Terasaka, Yokosuka-shi (JP)

(73) Assignee: Toshiba Lighting & Technology Corporation, Yokosuka-shi (JP)

(21) Appl. No.: 13/354,771

(22) Filed: Jan. 20, 2012

(30) Foreign Application Priority Data
Jan. 21, 2011 (JP) 2011-011391

(51) Int. Cl. H05B 37/02

(52) U.S. Cl. 315/307

(57) ABSTRACT

According to one embodiment, a lighting device includes a lighting circuit and a control circuit. The lighting circuit includes an output end to which an illumination lamp is connected, and lights the illumination lamp by a direct-current power. The control circuit controls the lighting circuit so that power consumption caused by a contact resistance at a connection part between the illumination lamp and the output end of the lighting circuit during whole light lighting of the illumination lamp does not exceed a specified value set to 8 W or less.

### INCORPORATION BY REFERENCE

The present invention claims priority under 35 U.S.C. §119 to Japanese Patent Application No. 2011-011391 filed on Jan. 21, 2011. The content of the application is incorporated herein by reference in its entirety.

### FIELD

Embodiments described herein relate generally to a lighting device to light an illumination lamp by a direct-current power supply and a luminaire.

### BACKGROUND

An illumination lamp including an LED is lit by a direct-current power. In order to light the illumination lamp by the direct-current power supply irrespective of the kind of the illumination lamp, a direct-current power supply lighting circuit is used.

On the other hand, if contact resistance of a connection part between the illumination lamp and the lighting circuit, for example, a connection part between a cap of the illumination lamp and a socket of the lighting circuit becomes large, there is a fear that the temperature of the connection part abnormally rises during lighting of the illumination lamp. When the temperature of the connection part abnormally rises, if the periphery of the connection part is formed of a plastic member or the like, there is a fear that the plastic member transforms from the softened state to the molten state or from the softened state to the deformed state, and the function of the connection part is broken.

Besides, in the state where the connection of the connection part is lost, an arc discharge becomes liable to occur. In the case of lighting by the direct-current power, when the arc discharge once occurs, there is a fear that the arc discharge is continued. When the arc discharge occurs, there is a fear that the temperature of the connection part abnormally rises, and the same disadvantage as that in the abnormal temperature rise due to the contact resistance occurs.

Then, a safety circuit can be provided which turns off the illumination lamp or reduces the light output when the temperature of the connection part abnormally rises or the arc discharge occurs. For example, when an illumination lamp including an LED is connected to a constant-current control lighting circuit and is lit, when the arc discharge occurs in the lighting circuit or a load circuit by an open mode failure such as attachment and detachment of respective connection parts in the load circuit, defective contact, breaking of wire, or opening of wire bonding of the LED, the output voltage of the lighting circuit rises. Thus, a control part can be provided which reduces the DC output current for a specified time when the arc discharge is detected by detecting the rise.

Besides, in break arc characteristics of an electric contact pair, in the case of a copper electric contact pair, a result elquivalent to minimum arc voltage Vm=13 V and minimum arc current Im=0.43 A by Holm is obtained. If these conditions are made not to be satisfied, the occurrence of the arc discharge can be suppressed.

Thus, even if the contact resistance of the connection part between the illumination lamp and the lighting circuit becomes large, if the abnormal temperature rise or the occurrence of the arc discharge due to that can be suppressed, it is possible to prevent that the plastic member of the periphery of the connection part transforms from the softened state to the molten state or from the softened state to the deformed state, and the function of the connection part is broken. However, related art can not meet this.

An advantage of exemplary embodiments is to provide a lighting device and a luminaire, which prevents that abnormal temperature rise or arc discharge occurs due to increase of contact resistance of a connection part between an illumination lamp and a lighting circuit and a disadvantage occurs.

### BRIEF DESCRIPTION OF THE DRAWINGS

FIG. 1 is a block diagram showing a luminaire of a first embodiment.

FIG. 2 is a circuit view for explaining an equivalent circuit of a connection part of the luminaire.

FIG. 3 is a circuit view showing a luminaire of a second embodiment.

FIG. 4 is a graph for explaining a relation between voltage and power in a connection part at the time of lighting of the luminaire.

FIG. 5 is a circuit view showing a luminaire of a third embodiment.

### DETAILED DESCRIPTION

In general, according to one embodiment, a lighting device includes a lighting circuit and a control circuit. The lighting circuit includes an output end to which an illumination lamp is connected, and lights the illumination lamp by a direct-current power. The control circuit controls the lighting circuit so that power consumption caused by a contact resistance at a connection part between the illumination lamp and the output end of the lighting circuit during whole light lighting of the illumination lamp does not exceed a specified value set to 8 W or less.

By this, even when the contact resistance at the connection part between the output end of the lighting circuit and the illumination lamp is large, since the power consumed by the connection part is small, it is possible to reduce the fear that the temperature of the connection part abnormally rises, a plastic member or the like of the periphery of the connection part transforms from the softened state to the molten state or from the softened state to the deformed state, and the function of the connection part is broken.

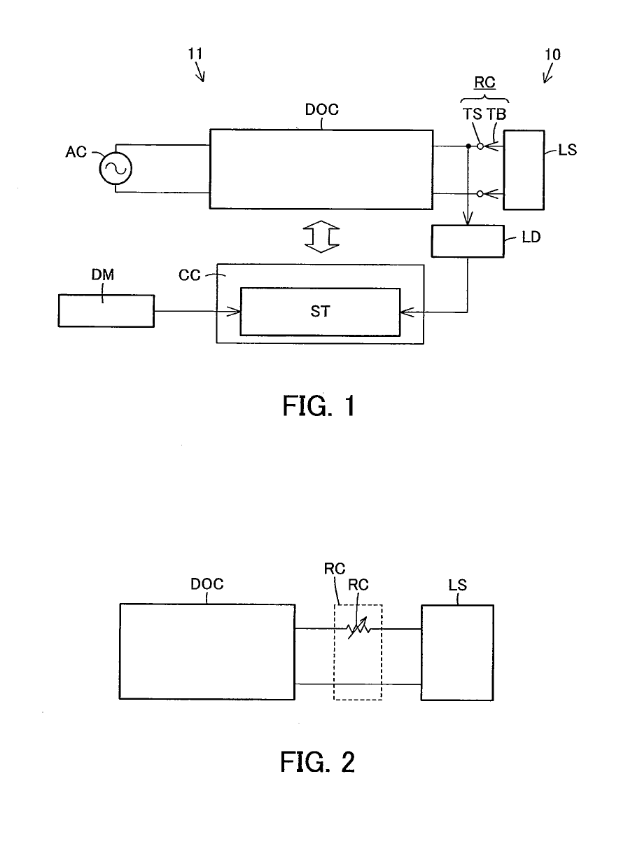

Next, a first embodiment will be described with reference to FIG. 1 and FIG. 2.

As shown in FIG. 1, a luminaire 10 includes an illumination lamp LS and a lighting device 11 including a lighting circuit DOC and a control circuit CC.

First, the illumination lamp LS will be described. As long as the illumination lamp LS is a lamp which can be lit by direct current, the other structure is not specifically limited. For example, the lamp may be a lamp using a semiconductor light-emitting element, such as an LED, an EL (Electro-Luminescence), an organic light-emitting diode (OLED) or an organic electro-luminescence (OEL), or well-known various lamps such as a fluorescent lamp and an incandescent lamp. In the case of the LED, plural LEDs are provided in order to obtain a desired amount of light. In this case, the plural LEDs can form a series connected circuit or a series-parallel circuit. However, the illumination lamp LS may include a single LED.

Besides, the illumination lamp LS may include a power receiving end TB to be connected to an output end TS of the lighting circuit DOC. Although the power receiving end TB has preferably a form of a cap, no limitation is made to this. Incidentally, as the cap, well-known various structures can be appropriately adopted. In brief, as long as the structure is for connection with the output end TS, the other structure is not specifically limited. For example, the power receiving end may have a form of a connector extended through a conductive wire from the main body of the illumination lamp LS. Besides, the power receiving end TB may be a connection conductor itself.

Further, the illumination lamp LS may have various forms. For example, the form may be a straight pipe shape in which caps are provided at both ends, or a single cap shape, as in an incandescent lamp, in which a screw cap is provided at one end.

Further, a desired number of illumination lamps LS can be connected in series to or in parallel to the lighting circuit DOC. Incidentally, when the parallel connection is performed, a constant-current circuit preferably intervenes so that load currents flowing through the respective parallel circuits are equalized.

Next, the lighting circuit DOC will be described. The lighting circuit DOC includes an input end connected to an alternating-current power supply AC and the output end TS to which the illumination lamp LS is connected, and supplies direct-current power to the illumination lamp LS through the output end TS to light the lamp. The output end TS has only to be structured so as to be fitted with the power receiving end TB of the illumination lamp LS, and the other structure is not specifically limited. For example, although the form of the socket is preferable, if the power receiving end TB of the illumination lamp LS has a form of a connector, the output end TS may have a form of a connector receiver. Besides, if the power receiving end TB has a form of a connection conductor, the output end TS may have a form of a terminal stand to receive the connection conductor.

Besides, the lighting circuit DOC may adopt a well-known circuit structure of voltage conversion, such as a DC-DC converter. As the DC-DC converter, for example, various choppers are preferable since the conversion efficiency is high and the control is easy. The DC-DC converter includes a direct-current input power supply and a direct-current voltage conversion part, and generally converts an input direct-current voltage into a direct-current voltage of different voltage. The output voltage of the direct-current voltage conversion part is applied to the illumination lamp LS. By controlling the direct-current voltage conversion part, the illumination lamp LS can be dimmed and lit to a desired level.

If the lighting circuit DOC is mainly composed of the DC-DC converter, the direct-current input power supply and the direct-current voltage conversion part can be arranged in one-to-one correspondence. Besides, the direct-current input power supply is made common, plural direct-current voltage conversion parts are provided in one-to-plural correspondence, and the direct-current input power supply may be supplied in parallel to the plural direct-current voltage conversion parts. Incidentally, in the latter case, when desired, the respective direct-current voltage conversion parts are provided at positions adjacent to the illumination lamp LS, and the common direct-current input power supply can be provided at a position separate from the illumination lamp LS.

Further, in order to facilitate the control of the control circuit CC to prevent the power consumption caused in a connection part RC from exceeding a specified value, the output characteristic of the lighting circuit DOC is preferably a constant-current characteristic or a constant-power characteristic. However, no limitation is made to this. Besides, a composite characteristic may be provided in which in a region where the lighting power of the illumination lamp LS is low, in other words, in a deep dimming region, constant-voltage control is performed, and in the other region, constant-current control is performed.

Further, the lighting circuit DOC can be constructed such that in order to change the operation state of the illumination lamp LS, the output of the lighting circuit DOC is varied according to a control signal, so that the direct-current power supplied to the illumination lamp LS is changed. That is, the illumination lamp LS can be dimmed and lit according to a dimming signal.

Next, the connection part RC will be described. The connection part RC includes the output end TS of the lighting circuit DOC and the power receiving end TB of the illumination lamp LS connected thereto. A variable contact resistance Rc as shown in an equivalent circuit of FIG. 2 is formed in the connection part RC between the output end TS and the power receiving end TB of the illumination lamp LS. With respect to this meaning, the connection part RC directly means the power receiving end TB and the output end TS themselves in the connection state. However, in this embodiment, from the point of avoiding the occurrence of a disadvantage due to the contact resistance Rc, the concept includes also connection parts of respective conductors connected to the input side and the output side of these members, that is, connection parts formed of the conductors.

Next, the control circuit CC will be described. The control circuit CC is the circuit to control the lighting circuit DOC so that the power consumption caused during whole light lighting of the illumination lamp LS by the contact resistance at the connection part RC between the power receiving end TB of the illumination lamp LS and the output end TS of the lighting circuit DOC does not exceed a specified value (whole light lighting time specified value). The specified value is set to 8 W or less. However, in order to further reduce the risk of occurrence of a disadvantage, the specified value is preferably set to 7 W or less.

In this embodiment, the lighting circuit DOC is controlled so that the power consumption caused during the whole light lighting of the illumination lamp LS by the contact resistance of the connection part RC does not exceed the specified value. Accordingly, even if the contact resistance of the connection part RC is large, it is possible to effectively suppress or avoid that a plastic member or the like of the periphery of the connection part transforms from the softened state to the molten state or from the softened state to the deformed state, and the function of the connection part is broken. Incidentally, the contact resistance of the connection part RC receives a direct influence by the quality of the conductive connection of the connection part RC. That is, when the contact resistance is large, this means that the conductive connection is insufficient, for example, the connection is loose. In the case where this embodiment is not used, there is a fear that in the above state, a vibration or shock is received from the outside during lighting of the illumination lamp LS, so that the coming-off of connection occurs at the connection part RC and an arc discharge is liable to occur. Besides, even when the coming-off of connection does not occur at the connection part RC, a load current flows, and power consumption is caused by the contact resistance. As a result, there is a fear that the temperature of the connection part RC abnormally rises, and a disadvantage, such as smoking, firing or deformation of the peripheral plastic member, is liable to occur.

When the power consumption caused by the contact resistance becomes large and exceeds the specified value, there is a fear that the arc discharge is liable to occur, and the amount of heat generation of the connection part RC becomes large during lighting of the illumination lamp LS and the temperature of the connection part RC is liable to abnormally rise.

In this embodiment, although the lighting circuit DOC is controlled so that the power consumption does not to exceed the specified value, the mode of the control may be varied. For example, the control is performed such that when the power consumption caused during the whole light lighting of the illumination lamp LS by the contact resistance of the connection part RC is about to exceed the specified value, the output of the lighting circuit DOC is reduced or stopped. Besides, the output of the lighting circuit DOC may always be feedback-controlled so that the power consumption does not exceed the specified value during the lighting of the illumination lamp LS. In the case of the control of the latter mode, since the power consumption of the connection part RC is always less than the specified value, even if the light output slightly changes according to the variation of the power consumption, the illumination lamp LS can be continuously lit.

Besides, in order to facilitate the control to prevent the power consumption caused by the contact resistance from exceeding the specified value, a power consumption detection circuit LD to detect the power consumption caused by the contact resistance of the connection part RC can be provided. The power consumption detection circuit LD may directly detect the voltage reduction of the connection part RC or the power consumption, or instead thereof, the power consumption detection circuit LD may be an indirect detection circuit to detect the output voltage of the lighting circuit DOC, the output power thereof, or the electric amount corresponding to the output voltage or the output power. In brief, the effective electric amount can be detected according to the control characteristic of the lighting circuit DOC.

For example, when the lighting circuit DOC has a constant-current control characteristic, since the load current at the time of whole light lighting is already known, and the load current is controlled to be constant, the output voltage of the lighting circuit DOC is mainly the sum of the load voltage and the voltage reduction generated at the contact resistor of the connection part RC. Since the load voltage is already known, if the output voltage is detected, the power consumption of the connection part RC can be indirectly obtained by calculation. Incidentally, also in this case, the output power may be detected instead of the output voltage.

When the constant-current control lighting circuit DOC is used and the power consumption of the connection part RC is indirectly detected as described above, also when an open mode failure occurs in the illumination lamp LS, the output voltage of the lighting circuit DOC rises. Thus, the power consumption detection circuit LD can detect this. Then, the control can be performed such that the control circuit CC reduces or stops the output of the lighting circuit DOC and the safe operation is performed. Accordingly, the circuit to perform such control that the power consumed by the contact resistance of the connection part RC does not exceed the specified value can be used also as the safety circuit at the time of occurrence of the open mode failure.

Besides, as shown in FIG. 1, although the control circuit CC is preferably constructed using a digital device mainly such as, for example, a microcomputer, an analog circuit may be used when desired. Incidentally, reference character ST in the drawing denotes an operation expression or a data table, which is configured so as to perform control by outputting the maximum data of output voltage of the lighting circuit DOC according to a dimming signal level. In brief, in this embodiment, the main part of the control circuit CC is constructed of the digital device, includes a CPU and a memory, and is configured to enable variable control of the illumination lamp LS, that is, dimming control by software configuration.

Next, a description will be made on a mode of a case where variable control is performed, for example, the illumination lamp LS is dimmed. That is, the lighting circuit DOC changes the magnitude of the load current according to a control signal from the outside, for example, a dimming signal generated from a dimming signal generation circuit DM. In this case, the control signal is inputted to the control circuit CC, an operation is performed using the operation expression or data table ST to determine a control amount, and the lighting circuit DOC is controlled, so that the dimming control is performed.

Incidentally, as long as the luminaire 10 of this embodiment includes the illumination lamp LS, the lighting circuit DOC and the control circuit CC described above, the other structure is arbitrary. Besides, although its application is generally for lighting, no limitation is made to this. Besides, in addition to the illumination lamp LS, the lighting circuit DOC and the control circuit CC, the luminaire 10 includes a luminaire main body for the purpose of supporting these members.

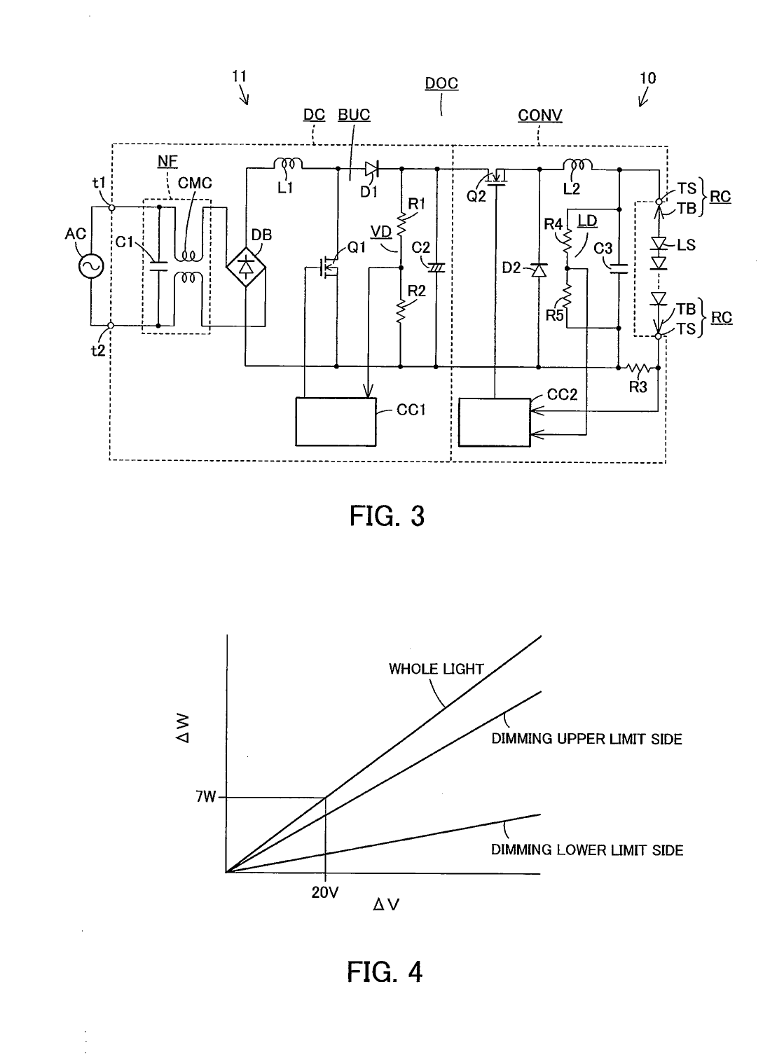

Next, a second and a third embodiment will be described with reference to FIG. 3 to FIG. 5. Incidentally, the same portion as that of FIG. 1 is denoted by the same reference character and its description is omitted.

The second embodiment will be described with reference to FIG. 3 and FIG. 4.

An illumination lamp LS has a straight tube shape, plural series-connected LEDs are dispersed and arranged in a not-shown straight tube-shaped outer tube, and power receiving ends TB formed at both ends form pin-shaped caps.

A lighting circuit DOC includes input ends t1 and t2, output ends TS and TS, a noise filter circuit NF, a direct-current input power supply DC, a DC-DC converter CONV, and a power consumption detection circuit LD.

An alternating-current power supply AC is connected to the input ends t1 and t2.

Each of the output ends TS and TS forms a socket, and the power receiving ends TB and TB forming the pin-shaped caps at both ends of the illumination lamp LS are connected thereto.

The noise filter circuit NF prevents an erroneous operation due to a noise entering from the power supply line, and prevents a noise generated in the lighting circuit DOC from leaking to the power supply line. Then, one end of the noise filter circuit is connected to the input end t1, t2, and the other end is connected to an input end of the direct-current input power supply DC.

Besides, although the specific circuit structure of the noise filter circuit NF is not specifically limited, well-known various noise filter circuits can be suitably selected and used. In the illustrated embodiment, the noise filter circuit includes a capacitor C1 and common mode choke coils CMC. The capacitor C1 is connected between the input ends t1 and t2. The common mode choke coils CMC are respectively inserted in series to a pair of lines between the capacitor C1 and the direct-current input power supply DC.

As long as the direct-current input power supply DC includes a circuit that converts alternating-current power from the alternating-current power supply AC into direct-current power and supplies the direct-current power, as the input, to the DC-DC converter CONY as the latter stage circuit element, the other structure is not specifically limited. The input end is connected to an output end of the noise filter circuit NF. In the illustrated embodiment, the direct-current input power supply DC includes a rectifier circuit, a power factor improving circuit and a smoothing circuit. As the rectifier circuit, a bridge full-wave rectifier circuit DB is used. As the power factor improving circuit and the smoothing circuit, a boost chopper circuit BUC is provided. Incidentally, in the above structure, an alternating-current input end of the bridge full-wave rectifier circuit DB is the input end of the direct-current input power supply DC.

In the booster chopper circuit BUC, a series circuit of an inductor L1 and a switching element Q1 is connected between the direct-current output ends of the bridge full-wave rectifier circuit DB, and a series circuit of a diode D1 and a smoothing capacitor C2 is connected in parallel to the switching element Q1. Both ends of the smoothing capacitor C2 are output ends of the direct-current input power supply DC.

Besides, a voltage dividing circuit VD including a series circuit of resistors R1 and R2 is connected in parallel to the smoothing capacitor C2, and the output voltage of the direct-current input power supply DC is divided and is feedback-inputted to a control circuit CC1. The control circuit CC1 supplies a drive signal to a control terminal of the switching element Q1 to control switching, and controls the switching element Q1 so as to improve the power factor of the direct-current input power supply DC with respect to the alternating-current power supply AC. Incidentally, for example, a MOSFET is used as the switching element Q1, and a gate terminal thereof is applied with a gate drive signal voltage from the control circuit CC1.

The circuit operation of the direct-current input power supply DC will be briefly described. When the switching element Q1 is turned on, a linearly increasing current flows from the direct-current input power supply DC to the inductor L1, and electromagnetic energy is stored in the inductor L1. When the terminal voltage of the smoothing capacitor C2 reaches a specified value, the control circuit CC1 turns off the switching element Q1. By this, the electromagnetic energy stored in the inductor L1 is released, and a linearly decreasing current flows through a circuit of the inductor L1, the diode D1, the smoothing capacitor C2 and the bridge full-wave rectifier circuit DB. By repeating the above circuit operation, a direct-current voltage which is smoothed, is boosted to become higher than the AC voltage, and is constant-voltage controlled is generated between both ends of the smoothing capacitor C2, that is, between the output ends of the direct-current input power supply DC, and is outputted from the direct-current input power supply DC.

The DC-DC converter CONV inputs the direct-current power supplied from the direct-current input power supply DC, converts the voltage of the inputted direct-current power into a desired voltage, outputs it, and lights the illumination lamp LS. The other structure is not specifically limited. Incidentally, the DC-DC converter CONV is a device to convert an inputted direct-current power into a direct-current power of a different voltage, and is a device also called a forward conversion device, and includes a flyback converter, a forward converter, a switching regulator and the like in addition to various choppers.

In the illustrated embodiment, the DC-DC converter CONV is formed of a step-down chopper. A series circuit of a switching element Q2, an inductor L2 and an output capacitor C3 is connected to the output end of the direct-current input power supply DC, that is, the output end of the booster chopper in this embodiment.

Besides, a series circuit of a diode D2 and the output capacitor C3 is connected in parallel to the inductor L2, and a closed circuit of those is formed. The output ends TS and TS are connected to both ends of the output capacitor C3 through a resistor R3 for current detection, so that the step-down chopper is formed. The on and off of the switching element Q2 is controlled by a control circuit CC2. The voltage of the resistor R3 for current detection is control-inputted to the control circuit CC2, and controls the off of the switching element Q2. By this, the DC-DC converter CONV constant-current controls the illumination lamp LS.

The power consumption detection circuit LD includes a voltage dividing circuit including resistors R4 and R5, is connected to the pair of output ends TS and TS of the DC-DC converter CONV, and detects the output voltage of the lighting circuit DOC.

The circuit operation of the DC-DC converter CONV including the step-down chopper will be briefly described. When the switching element Q2 is turned on, the linearly increasing current flows into the inductor L2 through the switching element Q2 from the output end of the direct-current input power supply DC, and the electromagnetic energy is stored in the inductor L2. When the increasing current detected through the voltage of the resistor R3 reaches the specified value, the control circuit CC2 turns off the switching element Q2. When the switching element Q2 is turned off, the electromagnetic energy stored in the inductor L2 is released, and the linearly decreasing current flows. When the decreasing current becomes 0, the control circuit CC2 again turns on the switching element Q2. Thereafter, the foregoing operation is repeated.

In this embodiment, the power consumption detection circuit LD monitors the increase of the output voltage of the lighting circuit DOC, and detects a power consumption ΔW caused by a contact resistance Rc of a connection part RC. Then, an increasing output voltage ΔV detected by the power consumption detection circuit LD is control-inputted to the control circuit CC2. The control circuit CC2 controls the DC-DC converter CONV so that the detected increasing output voltage ΔV does not exceed a specified value, for example, 20 V, and causes the lighting circuit DOC to perform a safety operation.

Next, a relation between ΔV changing according to the lighting state of the illumination lamp LS and power consumption ΔW caused by the contact resistance Rc will be described with reference to FIG. 4. In FIG. 4, the horizontal axis indicates ΔV, and the vertical axis indicates ΔW. A graph “whole light” shows a relation in the case of whole light lighting of the illumination lamp LS, a graph “dimming upper limit side” shows a relation in the case of dimming lighting on the upper limit side of the illumination lamp LS, and a graph “dimming lower limit side” shows a relation in the case of dimming lighting on the lower limit side of the illumination lamp LS. Incidentally, a load current at the time of whole light lighting is 0.35 A.

As is understood from FIG. 4, if the illumination lamp LS is in the whole light lighting, when ΔV is 20 V, the power consumption ΔW caused by the contact resistance Rc of the connection part RC becomes 7 W. Accordingly, the specified value is made 7 W, and if the control circuit CC2 is controlled when ΔV reaches 20 V and the lighting circuit DOC is made to perform the safety operation, the power consumption ΔW (dimming time specified value) caused by the contact resistor Rc of the connection part RC does not exceed 7 W. Thus, the foregoing disadvantage can be avoided. Incidentally, in the case of dimming lighting, also in the whole dimming region including the upper limit side and the lower limit side, when ΔV reaches 20 V, the safety operation can be performed. As stated above, if the value of ΔV set as the threshold of ΔW at the time of whole light lighting is used as the threshold in the whole region of dimming, the occurrence of disadvantage in the connection part RC can be prevented in the whole lighting region.

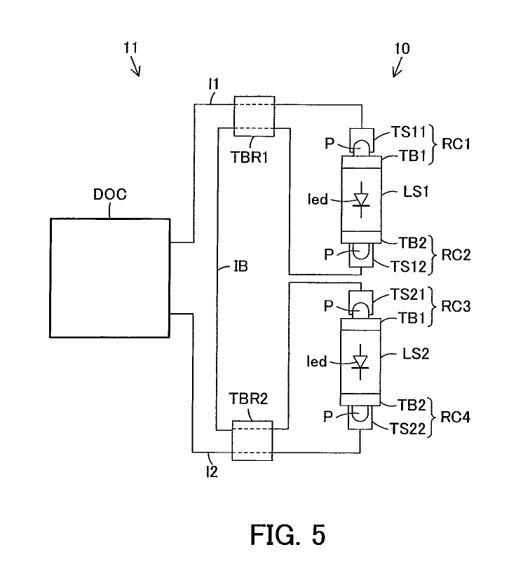

Next, the third embodiment will be described with reference to FIG. 5. In this embodiment, two illumination lamps LS1 and LS2 are series connected to output ends TS of a lighting circuit DOC. These illumination lamps LS1 and LS2 have the same structure, and each of the lamps contains plural series-connected LEDs led in a tube-shaped outer tube, and includes, as power receiving ends, a pair of caps TB1 and TB2 at both ends. Besides, each of the caps TB1 and TB2 includes a connection pin P.

On the other hand, the single lighting circuit DOC is provided with a pair of a first and a second sockets TS11 and TS12 and a pair of a first and a second sockets TS21 and TS22 correspondingly to the two illumination lamps LS1 and LS2. The first socket TS11 of one of the pairs is connected to an upper output line 11 of the lighting circuit DOC in FIG. 5 through a terminal stand TBR1. The second socket TS22 of the other of the pairs is connected to a lower output line 12 of the lighting circuit DOC in the drawing through a terminal stand TBR2. The second socket TS12 of one of the pairs is connected to one end of a connecting line IB through the terminal stand TBR1. The first socket TS21 of the other of the pairs is connected to the other end of the connecting line IB through the terminal stand TBR2.

From the above structure, the upper output line 11 in the drawing of the lighting circuit DOC is connected in series to the lower output line 12 in the drawing of the lighting circuit DOC through the one terminal stand TBR1, the first socket TS11 of one of the pairs, the one illumination lamp LS1, the second socket TS12 of one of the pairs, the one terminal stand TBR1, the connecting line IB, the other terminal stand TBR2, the first socket TS21 of the other of the pairs, the other illumination lamp LS2, the second socket TS22 of the other of the pairs and the other terminal stand TBR2, and forms a series lighting circuit of the pair of the illumination lamps LS1 and LS2.

In the above mode of the connection, the first socket TS11 of one of the pairs and the one cap TB1 of the one illumination lamp LS1 form a first connection part RC1, the second socket TS12 of one of the pairs and the other cap TB2 of the one illumination lamp LS1 form a second connection part RC2, the first socket TS21 of the other of the pairs and the one cap TB1 of the other illumination lamp LS2 form a third connection part RC3, and the second socket TS22 of the other of the pairs and the other cap TB2 of the other illumination lamp LS2 form a fourth connection part RC4. The respective connection parts RC1 to RC4 are series-connected to each other.

Accordingly, irrespective of the series number and the inner structure of the pair of illumination lamps LS1 and LS2 connected between the pair of the output lines 11 and 12, the lighting circuit DOC performs the control so that the power consumption ΔW caused by the contact resistance Rc of the whole of the respective connection parts RC1 to RC4 formed by those does not exceed the specified value. Thus, in the case of the two series-connected lamps, ½ of the specified value becomes a control threshold for the single illumination lamp LS. Thus, in this embodiment, the control is performed so that the power consumption caused by the contact resistance per lamp becomes ½, and the circuit efficiency of the luminaire becomes high. Besides, if plural illumination lamps are series connected, it is easily understood that the power consumption caused by the contact resistance per lamp becomes 1/(the number of lamps).

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A lighting device comprising:
a lighting circuit that includes an output end to which an illumination lamp is connected, and lights the illumination lamp by a direct-current power; and
a control circuit that controls the lighting circuit to prevent power consumption, which is caused by a contact resistance at a connection part between the illumination lamp and the output end of the lighting circuit during whole light lighting of the illumination lamp, from exceeding a specified value set to 8 W or less.

2. The device of claim 1, wherein
the lighting circuit includes a constant-current control characteristic, and
the control circuit controls the lighting circuit to perform dimming control of the illumination lamp, and in the dimming control, the control circuit sets a dimming time specified value of the power consumption, which is caused by the contact resistance at the connection part between the output end of the lighting circuit and the illumination lamp, to a value not exceeding the specified value set during the whole light lighting, and controls the lighting circuit to prevent the power consumption from exceeding the set dimming time specified value.

3. The device of claim 1, further comprising a power consumption detection circuit to detect the power consumption, wherein
the control circuit controls the lighting circuit to prevent the power consumption detected by the power consumption detection circuit from exceeding the specified value.

4. The device of claim 1, wherein the illumination lamp includes, as a light source, one of an LED, an EL, an organic light-emitting diode and an organic EL.

5. The device of claim 1, wherein the lighting circuit is one of a chopper, a flyback converter, a forward converter and a switching regulator.

6. A luminaire comprising:
an illumination lamp;
a lighting circuit that includes an output end to which the illumination lamp is connected, and lights the illumination lamp by a direct-current power; and
a control circuit that controls the lighting circuit to prevent power consumption, which is caused by a contact resistance at a connection part between the illumination lamp and the output end of the lighting circuit during whole light lighting of the illumination lamp, from exceeding a specified value set to 8 W or less.

7. The luminaire of claim 6, wherein
the lighting circuit includes a constant-current control characteristic, and
the control circuit controls the lighting circuit to perform dimming control of the illumination lamp, and in the dimming control, the control circuit sets a dimming time specified value of the power consumption, which is caused by the contact resistance at the connection part between the output end of the lighting circuit and the illumination lamp, to a value not exceeding the specified value set during the whole light lighting, and controls the lighting circuit to prevent the power consumption from exceeding the set dimming time specified value.

8. The luminaire of claim 6, further comprising a power consumption detection circuit to detect the power consumption, wherein
the control circuit controls the lighting circuit to prevent the power consumption detected by the power consumption detection circuit from exceeding the specified value.

9. The luminaire of claim 6, wherein the illumination lamp includes, as a light source, one of an LED, an EL, an organic light-emitting diode and an organic EL.

10. The luminaire of claim 6, wherein the lighting circuit is one of a chopper, a flyback converter, a forward converter and a switching regulator.
